(19) United States
(12) Patent Application Publication
(10) Pub. No.: US 2021/0018094 A1
(43) Pub. Date: Jan. 21, 2021

(54) RING DAM AND METHOD FOR MANUFACTURING A RING DAM

(71) Applicant: R & D PLASTICS OF HICKORY, LTD., Hickory, NC (US)

(72) Inventors: Mark A. Duncan, Hickory, NC (US); Paul A. Johnson, Hickory, NC (US)

(21) Appl. No.: 16/605,747

(22) PCT Filed: Apr. 4, 2018
(86) PCT No.: PCT/US2018/026056

§ 371 Date: Oct. 16, 2019

Related U.S. Application Data
(60) Provisional application No. 62/486,832, filed on Apr. 18, 2017.

(51) Int. Cl. F16J 15/02; B29D 99/00

(52) U.S. Cl. CPC F16J 15/027; B29K 2023/083; B29D 99/0053

(57) ABSTRACT

A ring dam, fitting between a fluid container and a housing for the fluid container, may include an extruded Polyethylene (EPE) foam having an Ethylene-Vinyl Acetate (EVA) additive.

### CROSS-REFERENCE TO RELATED APPLICATIONS

This application claims the priority of International Application No. PCT/US2018/026056 filed on Apr. 4, 2018 which claims the priority of U.S. Provisional Application No. 62/486,832 filed on Apr. 18, 2017, the entire contents of each is hereby incorporated by reference in the entirety.

### TECHNICAL FIELD AND BACKGROUND OF THE INVENTION

The present invention relates generally to insulated fluid containers. More particularly, the present invention relates to a ring dam made from polyethylene fitting between a housing and a container for facilitating the application of insulation between the housing and the container.

It is often desirable to store fluid in containers and to thermally insulate the fluid from exterior environments. For instance, it may be desirable to store heated water or other fluid in a container such that heat loss from the fluid is kept to a minimum. Such water may be heated and stored in a same tank. A housing may envelope the tank and an insulation may be applied between the tank and the housing in order to provide the thermal insulation.

In certain applications, such as for gas fired or other open flame heating applications, it may be desirable to apply an expanding, thermally insulating foam in order to fill the void between the housing and the tank. However, because the expanding, thermally insulating foam expands to fill the void, it is necessary to provide a lower boundary beyond which the foam may not pass. Such a lower boundary may be in the form of a ring dam. Unfortunately, many existing ring dams are expensive to manufacture, are not pliable, are difficult to install, or otherwise provide leak paths through which the expanding foam may leak during installation.

Thus, there is a need in the art for a ring dam which is easy to manufacture, which is pliable, bendable, easy to install, and which minimizes or eliminates leak paths.

### BRIEF SUMMARY OF THE INVENTION

It is therefore an object of the present invention to provide a ring dam which is easy to manufacture, which is pliable, bendable, easy to install, and which minimizes or eliminates leak paths.

It is another object of the present invention to provide a ring dam which may be made via an extrusion process.

It is a further object of the invention to provide a ring dam which may be heat welded to form a continuous ring.

To achieve the foregoing and other aspects and advantages, in one embodiment a ring dam fits between a fluid container and a housing for the fluid container and includes an extruded Polyethylene (EPE) foam having an Ethylene-Vinyl Acetate (EVA) additive.

According to another embodiment of the invention, the EPE foam may include a first end and a second end. The first end and the second end may be heat welded together to form a continuous ring.

According to another embodiment of the invention, the EPE foam may have a cylindrical shape before the first and second ends are heat welded and it may have a generally torus shape after the first and second ends are heat welded.

According to another embodiment of the invention, the EPE foam may have a cross section resembling a mechanical cog.

According to another embodiment of the invention, the EPE foam may include a central void. The central void may have a hollow cylindrical shape before the first and second ends are heat welded and it may have a generally hollow torus shape after the first and second ends are heat welded. The central void may consist of a single void only.

According to a method of manufacturing a ring dam, fitting between a fluid container and a housing for the fluid container, the method may include the steps of extruding Polyethylene (EPE) foam having an Ethylene-Vinyl Acetate (EVA) additive through a die. A further step may include allowing the EPE foam to cure. A further step may include cutting the EPE foam into a predetermined length such that the EPE foam has a first end and a second end. A further step may include heat welding the first end and the second end together to form a continuous ring.

According to another embodiment of the method of manufacturing a ring dam, the predetermined length may be no longer than the circumference or perimeter of the fluid container.

According to another embodiment of the method of manufacturing a ring dam, the die may be configured to impart a central void in the ring dam.

According to another embodiment of the method of manufacturing a ring dam, the die may be configured to impart a lateral cross-section in the ring dam having a furthest extent which is larger than a shortest distance between the fluid container and the housing.

According to another embodiment of the method of manufacturing a ring dam, the furthest extent may be in the range of 5 percent to 20 percent larger than the shortest distance.

According to another embodiment of the method of manufacturing a ring dam, the die may be configured to impart a circular shape to a lateral cross-section in the ring dam such that the ring dam has a cylindrical shape prior to the heat welding step and has a torus shape after the heat welding step.

According to another embodiment of the method of manufacturing a ring dam, the heat welding step may utilize a heat fin.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

Features, aspects and advantages of the present invention are understood when the following detailed description of the invention is read with reference to the accompanying drawings, in which:

FIG. 1 is side end view of the invention;

FIG. 2 is a perspective view of the invention;

FIG. 3 is a cutaway environmental view of the ring dam installed in a water heater;

FIG. 4 is an opposite side end view of the invention;

FIG. 5 is a perspective view of the invention before it has been heat welded;

FIG. 6 is a top view of the invention after it has been heat welded;

FIG. 7A is a side end view of an embodiment of the invention with cog shaped profile

FIG. 7B is an opposite side end view of the invention; and

FIG. 8 is a partial side cutaway view of an embodiment of the invention with a cog shaped profile installed between a tank and a shell or housing.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

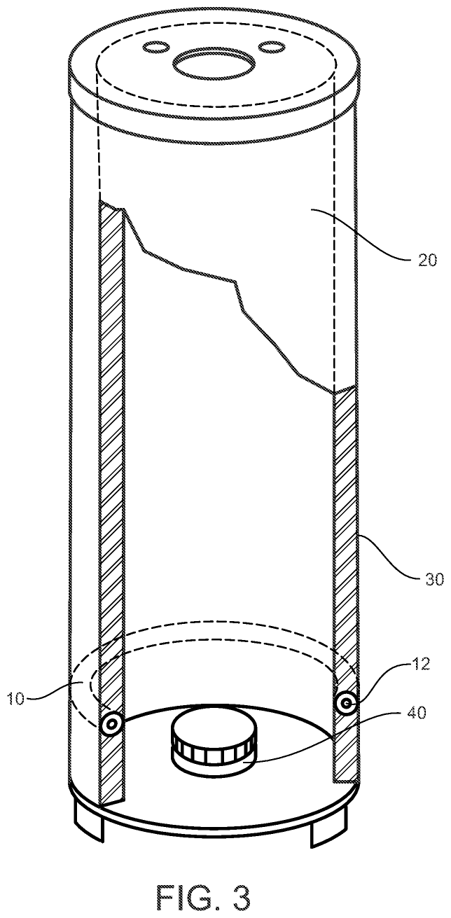

Referring to the figures, a ring dam 10 is shown. The ring dam 10 is a type of seal which fits between a fluid tank 20, such as a hot water heater tank, and an outer housing 30, such as the jacket for a hot water heater. The ring dam 10 may be used in many different applications. In particular, one such application, as shown in FIG. 3, is a fired appliance such as a natural gas or liquid petroleum gas hot water heater tank.

The ring dam 10 is put into place around the tank 20 and between the tank 20 and the jacket 30 by an installer who may use a tamper tool (not shown) to tamp the ring dam 10 down from the top of the tank 20 until the ring dam 10 reaches a predetermined distance from the top of the tank 20. As the ring dam 10 is tamped into place by the installer, it rolls and moves down the length of the tank 20. The tamper may have a length which equates to the predetermined distance from the top of the tank 20. When fully tamped and installed, the ring dam 10 forms a seal at a lower portion of the tank 20 so that expanding foam may be installed in the void between the tank 20 and the housing and above the ring dam 10. The ring dam 10 protects expanding foam insulation from encroaching the hot water heater burner 40 and the area.

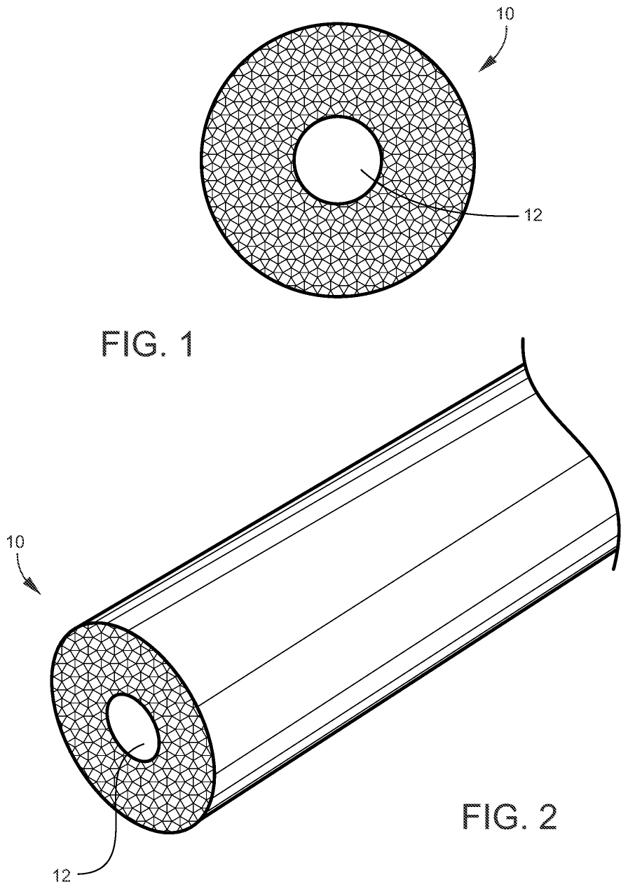

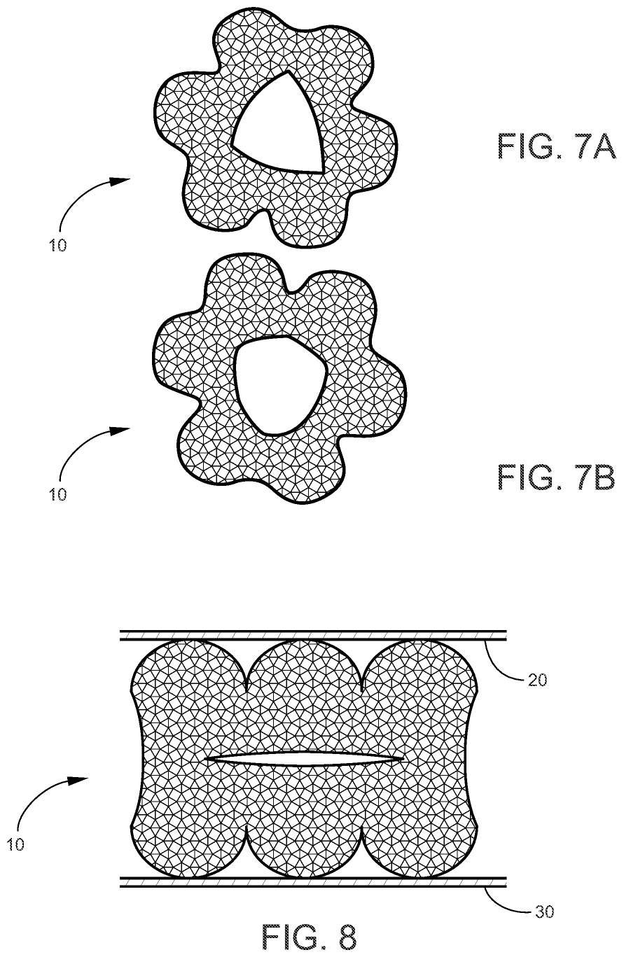

The ring dam 10 of the present invention is made from an extruded Polyethylene (EPE) foam having an Ethylene-Vinyl Acetate (EVA) additive. As shown in FIGS. 1-5, the ring dam 10 may have a circular cross section after being extruded and prior to installation. The ring dam 10 may also have a central void 12 as shown in FIGS. 1-5. The central void 12 may also have a circular cross section after being extruded and prior to installation. The ring dam 10 and the central void 12 may have other cross section shapes including the shapes shown in FIGS. 7-8.

The Polyethylene (EPE) foam having an Ethylene-Vinyl Acetate (EVA) additive is extruded through a die imparting the cross section shape and central void 12 as discussed above. The die also imparts a cross section diameter to the ring dam 10. The diameter of the cross section of the ring dam 10 corresponds to a particular application. That is, a smaller distance between the tank 20 and the jacket 30 would generally equate to a smaller cross section diameter of the ring dam 10. Likewise a larger distance between the tank 20 and the jacket 30 would generally equate to a larger cross section diameter of the ring dam 10. According to one embodiment, the diameter of the cross section of the ring dam 10 at a furthest extent is in the range of 5 percent to 20 percent larger than the shortest distance between the tank 20 and the jacket 30.

As the foam is extruded, the foam forms an elongate rod shape such as shown in FIGS. 2 and 5. The foam is allowed to cure. Once cured, the foam is cut into predetermined lengths. The predetermined length corresponds to the circumference or perimeter of the tank 20.

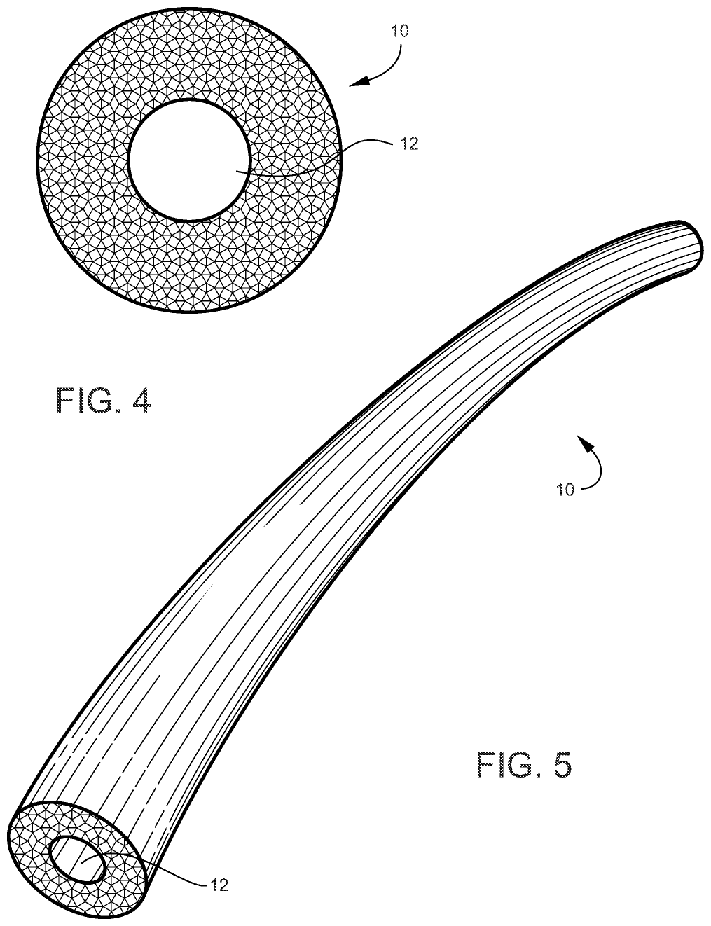

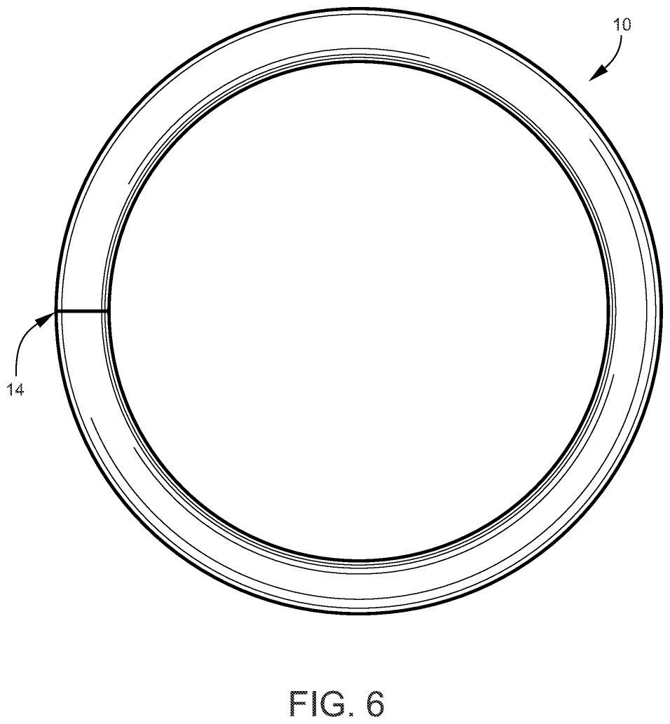

As part of the cutting process, a first end, FIG. 1, and a second end, FIG. 4, of the ring dam 10 are formed. The first and second ends are then heat welded 14 together to form a ring shape. The EVA additive may help strengthen the heat weld 14. For embodiments where there is a circular cross section, the ring dam will have a substantially torus shape.

A ring dam 10 according to the invention has been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims. It is envisioned that other embodiments may perform similar functions and/or achieve similar results. Any and all such equivalent embodiments and examples are within the scope of the present invention and are intended to be covered by the appended claims.

What is claimed is:

1. A ring dam, fitting between a fluid container and a housing for the fluid container, comprising:
an extruded Polyethylene (EPE) foam having an Ethylene-Vinyl Acetate (EVA) additive.

2. The ring dam of claim 1 wherein the EPE foam comprises a first end and a second end and wherein the first end and the second end are heat welded together to form a continuous ring.

3. The ring dam of claim 1 wherein the EPE foam comprises a central void.

4. The ring dam of Claim of claim 1 wherein the ring dam has a torus shape.

5. The ring dam of claim 1 wherein the central void has a torus shape.

6. A method of manufacturing a ring dam, fitting between a fluid container and a housing for the fluid container, comprising the steps of:
extruding Polyethylene (EPE) foam having an Ethylene-Vinyl Acetate (EVA) additive through a die;
allowing the EPE foam to cure;
cutting the EPE foam into a predetermined length, wherein the EPE foam has a first end and a second end; and
heat welding the first end and the second end together to form a continuous ring.

7. The method of manufacturing a ring dam according to claim 6 wherein the predetermined length is no longer than the circumference or perimeter of the fluid container.

8. The method of manufacturing a ring dam according to claim 6 wherein the die is configured to impart a central void in the ring dam.

9. The method of manufacturing a ring dam according to claim 6 wherein the die is configured to impart a lateral cross-section in the ring dam having a furthest extent which is larger than a shortest distance between the fluid container and the housing.

10. The method of manufacturing a ring dam according to claim 9 wherein the furthest extent is in the range of 5 percent to 20 percent larger than the shortest distance.

11. The method of manufacturing a ring dam according to claim 6 wherein the die is configured to impart a circular shape to a lateral cross-section in the ring dam such that the ring dam has a cylindrical shape prior to the heat welding step and has a torus shape after the heat welding step.

12. The method of manufacturing a ring dam according to claim 6 wherein the heat welding step utilizes a heat fin.
